(19) United States
(12) Patent Application Publication
(10) Pub. No.: US 2009/0017180 A1
(43) Pub. Date: Jan. 15, 2009

(54) METHOD FOR VOLUME DIVISION OF DOUGH AND IMPLEMENTING DEVICE

(75) Inventor: Claude Voegtlin, rue de Truchtersheim (FR)

Correspondence Address: EGBERT LAW OFFICES, 412 MAIN STREET, 7TH FLOOR, HOUSTON, TX, 77002, US

(73) Assignee: MECATHERM, Societe Anonyme, Barembach (FR)

(21) Appl. No.: 12/161,566

(22) PCT Filed: Jan. 22, 2007
(86) PCT No.: PCT/FR07/50672

§ 371 Date: Jul. 19, 2008

(30) Foreign Application Priority Data
Jan. 20, 2006 (FR) 06 50199
Feb. 6, 2006 (FR) 06 50413
Mar. 20, 2006 (FR) 06 50944

(51) Int. Cl. A21C 5/02

(52) U.S. Cl. 426/503; 425/202

(57) ABSTRACT

The invention concerns a method for volume division of bread-making, bakery, and pastry dough and the like, contained in a hopper. The method includes allowing the dough to flow by gravity into a chamber capable of measuring an amount of dough to be divided and extending beneath an opening located at the base of the hopper. The chamber is at least partly closed. The volume division of the dough into dough pieces of the amount of dough contained in the chamber is started. The divided dough pieces from the chamber are removed to be set on a discharge carrier. The invention also concerns a device for implementing the method.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to a method for volume division of bread-making, bakery and pastry dough or the like, contained in a hopper, as well as a device for implementing same, comprising a hopper containing said dough, provided in its lower portion with an opening communicating with a chamber capable of calibrating a quantity of dough to be divided.

The present invention falls within the field of the processing of bread-making, bakery and pastry dough or the like.

2. Description of Related Art

Including Information Disclosed Under 37 CFR 1.97 and 37 CFR 1.98.

In a known way, the volume division of bread-making dough into dough pieces is carried out through a hopper aimed at receiving said dough, the latter being stored in the lower portion of the hopper by natural gravity of the dough flowing along the inclined walls of said hopper. The latter ends at the lower portion are in a so-called “booster” chamber since the dough is drawn into it by suction under the action of pistons. The latter, five or six in total, even at most twelve for producing rolls of bread, are arranged contiguously over the entire length of the hopper and are moving horizontally, transversally to the longitudinal axis of said hopper.

Once the quantity of dough is sucked into the booster chamber, the latter is separated from the lower portion of the hopper by means of a knife, sliding and thus closing in said chamber. It should be noted that said knife partially closes the opening in the lower portion of the hopper, in order to permit the compression of the quantity of dough collected within the booster chamber, through the displacement of the pistons in the opposite direction. Indeed, the tightness of the chamber is not performed at the level of the lower portion of the hopper, in order to allow the removal, as the case may be, of the air still contained in the booster chamber or of an excess quantity of dough. Therefore, during the compression operation following the closing of the chamber by the knife, the excess quantity of dough can return into the hopper.

In this respect, the booster chamber is arranged in front of a measuring chamber, each one comprising reciprocally a booster piston and a measuring piston. As evoked above, the booster piston sucks the dough from the hopper in order to compress it towards the measuring chamber. The movement for compressing the dough by the booster piston pushes the measuring piston, which then moves back until a stop position. This stop is designed adjustable, in order to limit the travel distance of the measuring piston, thereby varying accordingly the volume of the measuring chamber and the size of the dough pieces formed.

A first disadvantage of the state of the art results from the very high stresses applied to the dough during its suction and its compression. The suction of the dough results in its tearing, and the following compression leads to sweating, in other words, removal of part of the water contained in the dough. At the same time, there is a destruction of the gas networks, which have been formed through fermentation during the stay of the dough in the hopper. Thus, the density of the dough tends to greatly increase and to reach values of about 1.2 to 1.3. The tensions stored in the dough, which has elasticity and a shape memory, will come out during the processing of the dough pieces, causing irregularity in the products obtained.

Furthermore, once the dough is enclosed and compressed in the booster chamber, through the simultaneous displacement of the booster piston and the measuring piston, this chamber is shifted so as to cause the measuring piston and the so defined dough piece to coincide with a vertical extraction corridor. This results into a vertical shift of this measuring piston and of said dough piece, in order to reach a discharge position in which the measuring piston ejects the dough piece onto a belt-type conveyer. This discharge is performed by a horizontal thrust of the measuring piston, the dough pieces sliding from the chamber onto said belt.

In addition to the fact that under the action of the measuring piston the dough is once again stressed, this discharge cycle is relatively complex, likely to generate and limit the rate of production.

According to another known solution, in particular from FR 2 172 446, the discharge of the dough pieces after division is ensured directly by the measuring piston, after pivoting of the booster chamber according to an angle of rotation of 45°.

Likewise, it is known, from FR 1 176 715, to vertically shift the booster chamber and its piston before orienting it according to a determined tilt angle, in order to be able to push the dough piece onto the discharge belt.

First of all, it should be noted that, in each of the solutions provided by these prior documents, the dough is either pushed or sucked out from the hopper for measuring and division. This dough is thus subjected to stresses prejudicial to the quality of the final product to be achieved.

Furthermore, though the devices described in these two documents of the state of the art improve the operation of extracting a dough piece, they do not provide full satisfaction. Indeed, the pushing of the dough piece out of its chamber deforms it because of the friction, which it is subjected to along the walls. This resistance to extraction is increased in the case of very soft dough. Indeed, this dough is the more fluid and sticky as it is hydrated, making its extraction very difficult.

As has been indicated above, these devices result into delivering dough pieces deformed at the outlet of the divider, so that it is necessary to provide for an additional operation to shape these dough pieces if it is desired to obtain a final product with a regular shape.

In addition, it is known, from WO 2004/043151, to seize the baked bread-making products by means of needles in order to extract them from their mould. These needles are arranged in front of each other, so as to be able to enclose the product with a view to this extraction from the mould. However, this has been contemplated only for baked products, hence products that have a determined rigidity and cohesion.

### BRIEF SUMMARY OF THE INVENTION

The aim of the present invention is to cope with the disadvantages of this state of the art. Thus, it is within the framework of a first inventive step that it has been contemplated to take the dough right from the hopper for division by simple gravity, this against the prejudices of the specialist of the art, who thinks that such a flow of the dough by gravity is completely unable to meet the usual rates of industrial productions of bread-making products and the like.

Furthermore, in a second inventive step, here too against any logic, it has been devised, after division, to extract the dough pieces from their compartment in the division chamber thanks to gripping means capable of seizing the dough piece in order to lay it on a discharge belt, rather than to push it onto this belt. In short, the invention was able to show that the deformation of the dough pieces can be controlled by seizing them, rather than by pushing them, to extract them from their housing.

In this way of thinking, the invention has made an additional step by contemplating that the gripping means could be in the form of needles, although the product to be seized is not rigid and baked, but as fluid and malleable as highly hydrated fresh dough can be. Indeed, because of this fluidity, the specialist in the art can only be diverted from such a solution by assuming that this fresh dough can only flow away between such needles. In short, the invention has been able to go against the prejudices of the specialist in the art.

Thus, the present invention relates to a method for volume division of bread-making, bakery, pastry dough or the like, contained in a hopper, wherein:
said dough is caused to flow by gravity into a chamber capable of measuring a quantity of dough to be divided and extending under an opening located at the base of said hopper;
said chamber is closed at least partially;
the volume division into dough pieces of the quantity of dough contained in said chamber is performed; and
said divided dough pieces are extracted from said chamber, in order to lay them on a support, in particular a discharge belt.

According to another feature of the invention, the dough flowing into the chamber is accompanied through a movable bottom the latter includes.

In particular, the quantity of dough to be divided is measured through the travel distance imparted to said movable bottom.

According to still another feature of the invention, each divided dough piece is individually seized from the chamber to lay it on said support.

Preferably, the dough pieces are accompanied during their extraction by the gripping means through the movable bottom of the chamber subdivided into a plurality of pistons controlled individually or per group.

The invention also relates to a device for volume division of bread-making, bakery, and pastry dough or the like, for implementing the preceding method, comprising a hopper containing said dough, said hopper being provided in its lower portion with an opening communicating with a chamber capable of calibrating a quantity of dough to be divided. The device comprises, on the one hand, means for cutting said quantity of dough into dough pieces in the form of means for subdividing said chamber into compartments and, on the other hand, means for mechanically extracting said dough pieces capable of laying the latter onto a discharge carrier. The chamber is so dimensioned as to be capable of receiving by gravity the quantity of dough corresponding to a minimum of twenty dough pieces, while the cutting means are designed to subdivide this chamber into at least twenty individual compartments capable of containing a dough piece.

According to another feature of this device, the bottom of the chamber is designed movable, in order, on the one hand, to accompany the flow of the dough by gravity into this chamber and, on the other hand, to modulate the volume of said chamber and calibrating a quantity of dough to be divided.

In particular, the movable bottom of the chamber is subdivided into a plurality of pistons, each one defining the bottom of a compartment.

According to still another feature of the invention, the means for mechanically extracting said dough pieces are formed by means for individually seizing each dough piece.

According to an advantageous embodiment, said gripping means are in the form of at least a pair of retractable needles.

In a very particular way, said needles are designed to penetrate into a compartment in the chamber to a depth adjusted to that of said compartment, thus of the position of the movable bottom said chamber includes.

According to the invention, the device comprises a stop capable of maintaining a dough piece, in order to extract the needles therefrom when laying it on the discharge carrier.

The advantages resulting from this invention essentially consist in that the dough is not subjected to any compression-type stress. Its taking over from the hopper occurs by simple gravity. Unexpectedly, the present invention therefore allows achieving rates equivalent to the prior solutions, which did however ensure a taking over by suction or pressure, thus mechanically, of the dough from this hopper. This result is achieved thanks to a chamber including a large number of compartments, whereas the way of thinking of the state of the art consisted in limiting, even reducing to a minimum, these compartments, in order to reduce the necessary suction power.

Thus, paradoxically, through the present invention, at the time of the division of the dough into dough pieces, this dough is subjected to no stress that alters its physical characteristics, therefore the division operation is no limiting factor in a chain for producing bread-making products.

In addition, the invention enhances the uniformity of the dough pieces and their laying through a mode of extraction adapting itself to the softest dough.

Other features and advantages of the invention will become clear from the following detailed description of non-restrictive embodiments of the invention, with reference to the attached figures.

### BRIEF DESCRIPTION OF THE SEVERAL VIEWS OF THE DRAWINGS

FIG. 1 represents a schematic perspective view of part of the device according to the invention.

FIGS. 2 to 6 are schematic cross-sectional representations of the main steps of the method according to the invention.

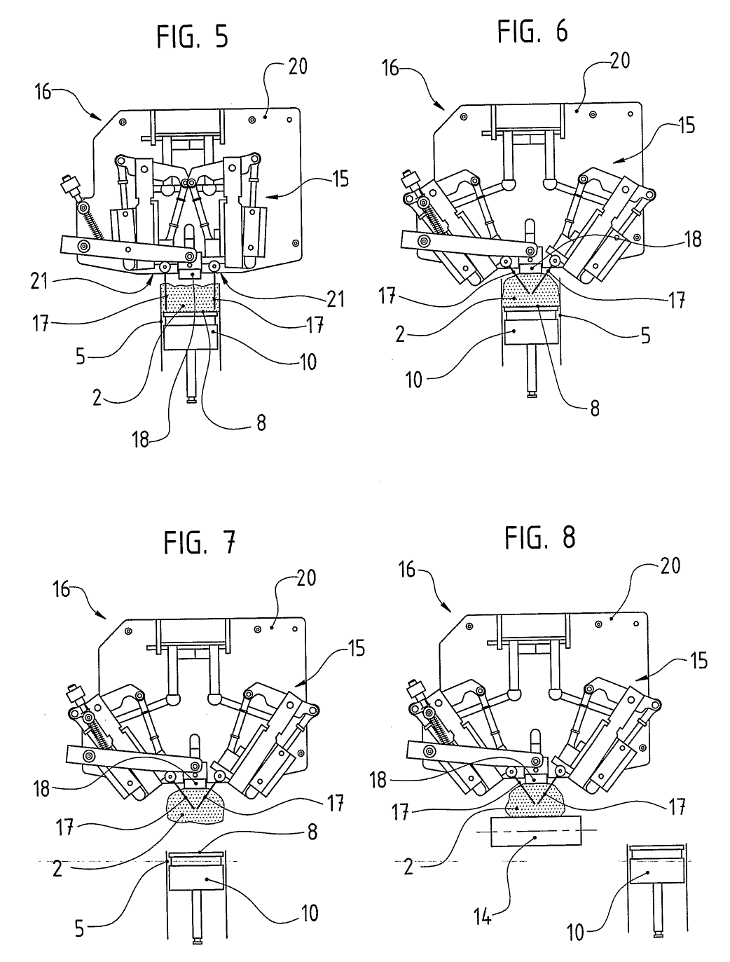

### DETAILED DESCRIPTION OF THE INVENTION

The present invention relates to the volume division of bread-making, bakery, and pastry dough 1 or the like into dough pieces 2.

To this end, the dough 1 is contained in a funnel-shaped hopper 3 in order to allow the flow of said dough 1 by gravity along its inclined walls 4. The dough 1 is thus stored in the lower portion of the hopper 3 communicating through an opening 7 with a chamber 6 capable of calibrating a quantity of dough to be divided.

Said chamber 6 extends under the hopper 3, over whole or part of the length of the latter and is aimed at receiving, through the flow by gravity of the dough 1 from the hopper 3, a quantity of dough to be divided into dough pieces 2.

An advantage of this invention consists in that the dough 1 is not subjected to any aspiration or suction stress. Indeed, the passing of the dough 1 from the hopper 3 towards the booster chamber 6 occurs under the action of its weight, by gravity.

This chamber 6 includes side walls 5 and a bottom 8. In particular, at least one of these walls, preferably the bottom 8, is designed movable, allowing measuring the dough 1 likely to be contained in the chamber and ensuring a calibration operation as will be explained further in the description.

Advantageously, this mobility of the bottom 8 of the chamber 6 permits to accompany the flow of the dough 1 from the hopper 3. Preferably, this bottom 8 is capable of moving vertically from top to bottom, and vice-versa.

Once the predefined quantity of dough 1 has been poured into the chamber 6, the latter is closed at least partially, preferably completely. The closing of chamber 6 results from the closing of the opening 7 in the lower portion of the hopper 3, this by means of a cutting tool 9, such as a blade extending longitudinally with respect to the hopper 3 and separating the latter from the chamber 6.

This cutting tool 9 is designed movable, preferably in horizontal translation, according to a transverse displacement with respect to the longitudinal axis of said hopper 3.

The next step of the method according to the invention consists of the volume division into dough pieces 2 of the quantity of dough 1 contained in said chamber 6.

To this end, the device according to the invention comprises means for cutting 11 said quantity of dough 1 into dough pieces 2, means for subdividing this chamber 6 into at least twenty different compartments 12 capable of containing a dough piece 2. These cutting means 11 are in the form of one or several knives 13 mounted movably in vertical displacement under the chamber 6. The translation of the knife 13 occurs over the full height of the latter, in order to cut the dough 1 into dough pieces 2, preferably of similar sizes. Once this uniform cutting has been performed, each knife 13 is maintained in the upper position, delimiting the compartments 12 inside the chamber 6.

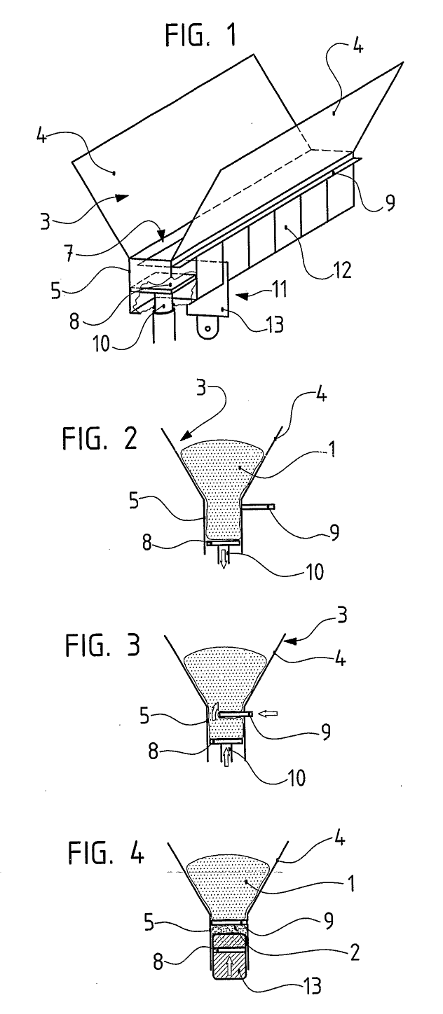

In this respect, the compartments 12 can be made so as to delimit transverse sections with respect to said chamber 6, over the whole or part of its length, as can be seen in FIG. 1. According to another embodiment, a longitudinal division of the chamber can be performed, whether in combination or not with a transverse division.

The knives 13 penetrate into the chamber 6 passing through gaps preserved at the level of one of the walls of this chamber 6. According to a preferred embodiment, the wall in question is the bottom 8, and the gaps for the passing through of the knives 13 delimit into wall sections each forming the bottom of a compartment 12. In fact, these wall sections are formed by pistons 10, and the aggregate of the latter forms said movable bottom 8.

Another essential feature of the invention consists in extracting the dough pieces 2 from the chamber 6 to lay them on a discharge carrier 14.

In this respect, the support 14 can be of any nature, fixed or movable, but preferably a conveyor, such as a conveyor belt or the like. This discharge carrier 14 can convey dough pieces 2 at the outlet of the chamber 6 towards the further steps of the production of bread-making, bakery, pastry or the like.

Furthermore, the device for volume division includes means for mechanically extracting 16 said dough pieces 2 capable of laying the latter on this discharge carrier 14.

Advantageously, the method according to the invention consists in seizing individually each dough piece 2 in its compartment 12 in the chamber 6 in order to lay it on said support 14.

To this end, the mechanical extraction means 16 are formed of means for individually seizing 15 each dough piece 2. This seizing can ideally be performed by a device with retractable needles or claws 17. In particular, each dough piece 2 can be seized by at least one pair of needles 17.

Thus, these gripping means 15 are capable of removing said dough pieces 2 from their compartment 12 in said chamber 6 through at least partial penetration of the pairs of needles 17 inside each dough piece 2. To this end, said needles 17 extend vertically in front of each other and are mounted movable in translation so as to be capable of penetrating into the chamber 6, into the dough piece 2. This penetration occurs simultaneously.

It should be noted that the needles 17 are spaced apart from each other in an adjustable way, according to the width of the chamber 6 and/or the width of the compartment 12 container the dough piece 2 to be seized.

In particular, the distance between them is such that the needles 17 can penetrate into said chamber 6 or said compartment 12 delimited in the latter along two opposite side walls 5, while keeping a smaller distance with respect to the latter. This configuration can be seen in FIG. 5. Advantageously, said needles 17 are designed to penetrate into a compartment 12 to a depth adjusted to that of the latter, hence according to the position of the movable bottom 8 said chamber 6 includes. In short, the step of seizing the dough piece 2 is performed to a depth depending on the position of the piston 10 defining the bottom of the compartment 12 containing this dough piece 2. This allows penetrating deep into the dough piece 2, so as to permit its extraction without same getting deformed, thus so that it is useful to perform an additional operation to re-shape this dough piece.

The next step consists in tightening the engagement with the dough piece 2 through translation or rotation of the gripping means 15. To this end, the needles 17 are mutually mounted movable in translation or rotation, so that these needles 17 of each pair of needles 17 converge towards each other. According to the embodiment shown in FIG. 6, the needles 17 are movable in rotation so that their respective end is substantially in the same alignment, maintaining a firm engagement. It should be noted that the needles 17 of a pair of needles 17 can extend in one and the same vertical plane or in slightly shifted planes, in order to eventually be able to cross each other after rotation.

In short, said gripping means 15 comprise at least two needles 17 movable in directions converging with respect to each other, so as to ensure the seizing of said dough piece 2 after penetration into the latter.

More specifically, in an exemplary embodiment, the gripping means 15 include at least a number of pairs of needles 17 identical to the maximum number of dough pieces 2 that can be subdivided in the chamber 6. These pairs of needles 17 are mounted movably at the level of a gripping pallet 20, which can be above said chamber 6, after the calibration operation, this by displacement of the chamber 6 and/or the hopper 3. At that time, said pairs of needles 17 are in a withdrawn position in adapted openings 21, above the compartments 12 containing the dough pieces 2 to be seized.

It should thus be noted that the needles 17 are controlled and articulated so as to pass from a withdrawn position to a gripping position protruding with respect to said pallet 20, and vice-versa.

These gripping means 15, in particular the needles 17, can be designed to extract the dough pieces 2 directly from their compartments 12.

Preferably, the dough pieces 2 are accompanied during their extraction by these gripping means 15 through the movable bottom 8 of the chamber 6. In particular, the extraction of a dough piece 2 seized by the needles 17 is performed by accompanying the same during its displacement through a rise of the piston 10 defining the bottom 8 of a compartment 12.

More specifically, each piston 10 of each compartment 12 is designed capable of being controlled and actuated separately for a total or partial rise of the dough pieces 2.

Here too, like for the pistons 10, the needles 17 can be controlled per series, in order to alternatively seize two dough pieces 2 located side by side in the booster chamber 6, in order to lay them sequentially on the discharge carrier 14.

Another feature resides in that the device, advantageously the gripping means 15, comprises a stop 18 capable of maintaining a dough piece 2 in order to extract the needles 17 from same when laying it on said discharge carrier 14. More particularly, during the extraction of said needles 17, the dough piece 2 is blocked between this stop 18 and the support 14.

Then, the device returns into its initial position for a new cycle of seizing dough pieces 2.

Thus, after a first series of pairs of needles 17 have seized dough pieces 2, the gripping means 15 are moved so as to lay them on the discharge carrier 14. Then, in a new seizing cycle, they return above the chamber 6 from where a second series of dough pieces 2 can be removed, by activating a second series of pairs of needles 17 (or same series, but after translation of the gripping means 15), then lay them on this support 14. This sequence is thus repeated until complete emptying of said chamber 6.

The advantage of a positive seizing of the dough pieces 2 in order to lay them on the discharge carrier 14, in this case a transport belt, consists in that there is no risk that a dough piece 2, by adhering to another adjacent one, takes the latter along and disturbs its positioning on this transport belt. It should be reminded in this respect that on this positioning largely depends the quality of treatment, which these dough pieces 2 are subjected to downstream in the production line.

Another advantage of the invention resides in that the extraction of each dough piece 2 can be controlled. Indeed, since the chamber 6 is divided into compartment 12 provided, each, with a piston 10, it is possible to extract each dough piece 2 so as to separate them on the support 14. In particular, a regular arrangement of the dough pieces 2 on the support can be carried out, namely with an even distance between each dough piece 2. A homogeneous sequencing of the dough pieces 2 is then possible, in particular through the displacement of the support 14.

In short, this second embodiment will be of a very particular interest within the framework of the processing of soft dough, that is, fluid, wet and highly sticky dough.

In addition, if such is necessary, the method according to the invention provides an additional step consisting in cleaning and/or lubricating said chamber 6, in order to improve the following extraction, this periodically after a cycle of dough-piece extraction 2.

Another feature consists of the supply of dough 1 from said device according to the invention, in particular from the hopper 3. In order for the device to ensure a satisfactory filling of the booster chamber 6, it is then necessary to take precautions and particular care when introducing the dough 1 into said hopper 3. In particular, the weighing of the dough 1 inside the hopper 3 should be constant during the division process, while ensuring a similar level of dough 1 at any point of said hopper 3.

To this end, an additional hopper, not shown, is arranged above the hopper 3. Although its size is smaller, it is also shaped in the form of a funnel and an opening in the lower portion ends in said hopper 3.

A peculiarity resides in the putting into movement of this additional hopper, namely through a sliding-feed system. This moving hopper thus deposits, in the upper portion of said hopper 3, dough sections of an equivalent volume over the full open surface of said hopper 3.

In the lower portion of this additional hopper, means are capable of regulating the deposited dough pieces 1, namely through a programmed opening and closing of the lower portion. Thus, the quantity of dough released can be adjusted according to the flow rate of the hopper 3.

The placing thus occurs sequentially: the additional hopper depositing, when stopped; a dough piece 1, moving; then depositing another piece, etc. This sequence is however repeated continuously during the process.

In the case of several devices according to the invention mounted in parallel, one single additional hopper can be provided for uniformly feeding them with dough 1.

1. Method for volume division of bread-making, bakery, and pastry dough or the like, contained in a hopper said method comprising the steps of:
moving dough by gravity into a chamber forming a measured quantity, being divided and extended under an opening located at a base of said hopper;
at least partially closing said chamber;
dividing dough pieces of said measured quantity by volume;
extracting said divided dough pieces from said chamber onto a discharge carrier (14).

2. Method according to claim 1, wherein said chamber includes a movable bottom.

3. Method according to claim 2, wherein the step of dividing dough pieces comprises:
measuring through travel distance imparted to said movable bottom.

4. Method according to any of the preceding claims, wherein the step of extracting said dough pieces comprises:
individually seizing said dough pieces from the chamber onto said discharge carrier.

5. Method according to claim 1, wherein the step of extracting said dough pieces comprises:
accompanying gripping means through a movable bottom of the chamber with said dough pieces.

6. Method according to claim 1, further comprising:
cleaning and/or lubricating said chamber after the step of extracting said dough pieces.

7. Device for volume division of bread-making, bakery, and pastry dough or the like, for implementing the method claim 1, said device comprising:
a hopper containing dough, said hopper having lower portion with an opening;
a chamber in communication with said opening, said chamber being calibrated for a measured quantity of dough divided from said dough in said hopper;
means for cutting said measured quantity of dough into dough pieces said means for cutting being compartments in said chamber, said chamber being subdivided into said compartments; and
means for mechanically extracting said dough pieces and laying said dough pieces onto a discharge carrier, wherein said chamber is dimensioned to received said measured quantity of dough by gravity, wherein said dough pieces are at least twenty dough pieces, and wherein the cutting means is comprised of said chamber subdivided into at least twenty individual compartments corresponding to each dough piece.

8. Device according to claim 7, wherein said chamber has a bottom being moveable, accompanying flow of dough by gravity into said chamber, said bottom setting a volume of said chamber and calibrating said measured quantity of dough.

9. Device according to claim 8, wherein the movable bottom of the chamber is subdivided into a plurality of pistons, each piston defining a bottom of a compartment.

10. Device according to claim 9, wherein the pistons are controlled and actuated independently.

11. Device according to claim 7, wherein the means for mechanically extracting said dough pieces are comprised of means for individually seizing each dough piece.

12. Device according to claim 11, wherein said means for individually seizing is comprised of at least one pair of retractable needles.

13. Device according to claim 12, wherein the needles extend vertically in front of each other and are movable in translation, the needles penetrating into said chamber and into the dough piece.

14. Device according to claim 12, wherein the needles are spaced apart from each other in an adjustable way, depending on width of said chamber or width of the compartment containing the dough piece or both.

15. Device according to claim 12, wherein the needles penetrate into said chamber to a depth adjusted to a position of the movable bottom.

16. Device according to claim 8, wherein the needles are mounted in rotation or translation or both so as to converge towards each other, in order to seize the dough piece.

17. Device according to claim 12, further comprising:
a stop maintaining a dough piece with a view to extracting the needles when laying said dough piece on the discharge carrier.
